(19) United States
(12) Patent Application Publication
(10) Pub. No.: US 2016/0180335 A1
(43) Pub. Date: Jun. 23, 2016

(54) ALARM SERVICE

(71) Applicant: Empire Technology Development LLC, Wilmington, DE (US)

(72) Inventor: Seungil KIM, Seoul (KR)

(21) Appl. No.: 14/574,068

(22) Filed: Dec. 17, 2014

(51) Int. Cl. G06Q 20/36; G06Q 20/40; G06Q 20/38

(52) U.S. Cl. CPC G06Q 20/3674; G06Q 20/382; G06Q 20/401

(57) ABSTRACT

In some examples, a method to facilitate financial transactions includes receiving data relating to a financial transaction and determining whether a security token is presently available to authenticate the financial transaction. If the security token is not presently available to authenticate the financial transaction, the method also includes scheduling a reminder to execute the financial transaction when the security token becomes available.

### BACKGROUND

Unless otherwise indicated herein, the materials described herein are not prior art to the claims in the present application and are not admitted to be prior art by inclusion in this section.

Mobile money transfer systems provide a convenient way to transfer money between parties at any time and place. Thus, more and more people are using mobile money transfer applications (such as banking applications) on their mobile devices to complete financial transactions. However, mobile money transfer systems can be vulnerable to security breaches.

To help defend against security breaches, most money transfer systems typically require a security token to authenticate financial transactions. Security tokens can be used to prove one's identity electronically, as in the case of a customer trying to access their bank account. The security token can be used in addition to or in place of a password to prove that the customer is who they claim to be. Thus, a security token can be thought of as an electronic key to access computer services and/or authenticate financial transactions. Security tokens can be software security tokens (e.g., certificate of authentication) or hardware security tokens (e.g., One-Time Passwords derived from a security token device).

A problem may arise, however, when a user desires to execute a money transfer but the user does not currently have access to his or her security token. For example, two friends may meet to have dinner at a restaurant and one of them may pay for the entire meal because the other forgot to bring his wallet. The user who forgot his wallet may desire to pay his friend back with a quick money transfer via his mobile device. However, if the user does not currently have access to his security token (e.g., he left his security token at home) then he will have to remember to complete the money transfer after he returns home and has access to the security token. However, users may forget to complete the money transfer when they get to the place where the security token is located.

### SUMMARY

Technologies described herein generally relate to an alarm service.

In some examples, a method to facilitate financial transactions may include receiving data relating to a financial transaction. The method may also include determining that a security token is not presently available to authenticate the financial transaction. In response to determining that the security token is not presently available, the method may also include scheduling a reminder to execute the financial transaction when the security token becomes available.

In some examples, a system to facilitate financial transactions may include an input module configured to receive data related to a financial transaction. The system may also include a security token detection module configured to detect that a security token is not presently available to authenticate the financial transaction. The system may also include an alarm module configured to schedule a reminder to execute the financial transaction when the security token becomes available.

In some examples, a non-transitory computer-readable medium includes computer-readable instructions stored thereon that are executable by a processor to perform or control performance of operations that may include receiving data relating to a financial transaction. The operations may also include determining that a security token is presently available to authenticate the financial transaction. In response to determining that the security token is not presently available, the method may also include scheduling a reminder to execute the financial transaction when the security token becomes available.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings. In the drawings:

FIG. 1 is a block diagram of an example operating environment;

FIG. 2 is a block diagram illustrating an example alarm service support system to facilitate financial transactions;

FIG. 3 shows an example flow diagram of a method to facilitate financial transactions with an alarm service; and

FIG. 4 is a block diagram illustrating an example computing device configured to facilitate financial transactions with an alarm service, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the figures, can be arranged, substituted, combined, separated, and designed in a wide variety of different configurations, all of which are explicitly contemplated herein.

This disclosure is generally drawn, inter alia, to methods, apparatus, systems, devices, and computer program products that generally relate to facilitating financial transactions with an alarm service.

As an example, a security token dongle device of a user can be configured to generate security tokens, such as one-time passwords. However, if the dongle device is at another location than the user (not in the user's possession or proximate to the user) when the user desires to make financial transactions that require the dongle device and/or the one-time passwords for authentication, then the user may be unable to complete the financial transactions. Thus, a system and method are presented herein to remind the user to complete the financial transaction when the user comes in possession of or close proximity to the security token dongle device.

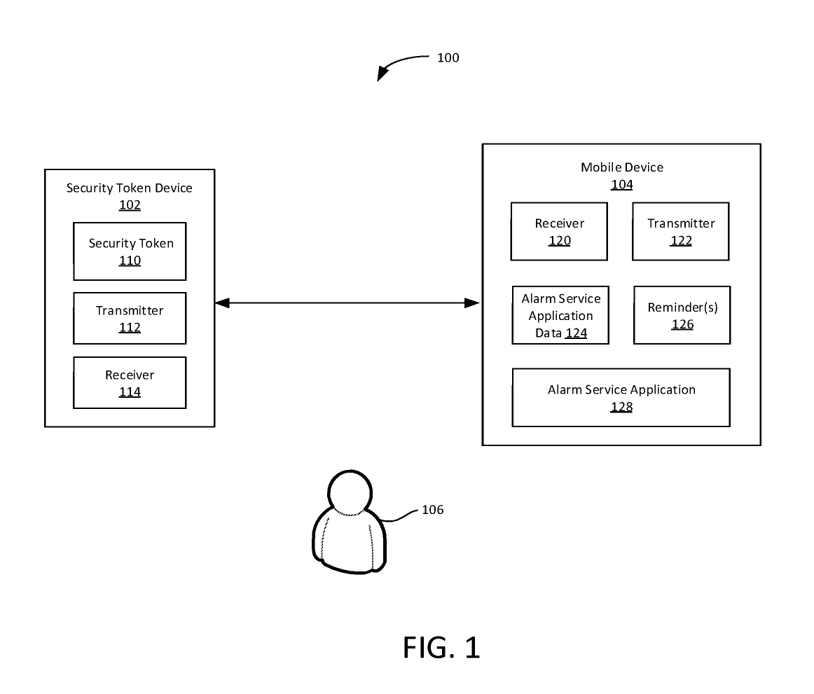

FIG. 1 is a block diagram of an example operating environment 100, arranged in accordance with at least some embodiments described herein. The operating environment 100 may include a security token device 102, a mobile device 104, and a user 106.

The security token device 102 may include a security token 110, a transmitter 112, and a receiver 114. The transmitter 112 and receiver 114 may be combined into a single functional unit, such as a transceiver, or may be separated into different functional units. Additionally, the security token device 102 can include other components not shown, such as a processor device, memory, a display, a key pad, a communication interface, or other input and/or output devices.

Example security token devices 102 may include: key fob devices, dongle devices, universal serial bus (USB) devices, radio-frequency identification (RFID) devices, Bluetooth® wireless devices, short message service (SMS) devices, unstructured supplementary service data (USSD) devices, smart card devices, personal computer memory card international association (PC card) devices, audio jack port devices, near-field communication (NFC) devices, and other suitable security token devices.

The security token 110 stored on the security token device 102 can help authenticate financial transactions and/or verify the identity of the user 106. The security token 110 can include a software security token or a hardware security token.

Software security tokens can be directly stored on the computing device that facilitates the financial transaction, such as the mobile device 104. Alternatively, or in addition thereto, software security tokens can be stored on a separate device and communicated to the computing device that facilitates the financial transaction. Two common software security token architectures include “shared secret” and “public-key cryptography” architectures. Shared secret software tokens typically utilize a configuration file for each end-user. The configuration file may contain a username, a personal identification number, and the secret. Public-key software security tokens utilize cryptographic algorithms to generate two keys, one of which is a private key and one of which is a public key. The private and public keys together form a key pair and are mathematically linked to each other. The private key can be used to create a digital signature and decrypt ciphertext. The public key can be used to verify the digital signature and encrypt plaintext.

Hardware security tokens are security tokens stored on a physical security token device, such as the security token device 102 of FIG. 1. Security token devices can be given to authorized users to help them authenticate their financial transactions. Security token devices can be “connected” security token devices or “disconnected” security token devices, depending on whether the security token device directly communicates the security token 110 to the mobile device 104. For example, a “disconnected” security token device may generate a one-time password (OTP) that the user can manually enter into the mobile device 104 to complete the authentication process. On the other hand, a “connected” security token device may directly communicate the security token 110 to the mobile device 104 without manual entry.

The transmitter 112 and the receiver 114 of the security token device 102 can be configured to operate in a wired or wireless configuration to exchange data with the mobile device 104. In at least some implementations described herein, the security token device 102 can wirelessly communicate with the mobile device 104 when the security token device 102 and the mobile device 104 are in close proximity to each other. In this manner, the security token device 102 can alert the mobile device 104 to its physical presence. In at least some implementations described herein, the security token device 102 can be configured to transmit beacon signals, such as Bluetooth® Low Energy pairing signals. These beacon signals can be transmitted at regular intervals to conserve power.

The mobile device 104 may include a receiver 120, a transmitter 122, alarm service application data 124, one or more reminders 126 (hereinafter “reminder” or reminders”), and an alarm service application 128. The mobile device 104 can also include other components not shown in FIG. 1, such as a processor device, memory, a display, a key pad, a communication interface, sensor(s), or other input and output devices.

The mobile device 104 may include: a cellular phone, a smartphone, a computer, a laptop, a tablet device, a personal digital assistant (PDA), a personal digital assistant (PDA), a smart watch, a wearable device, and/or any other suitable device that can be configured to facilitate financial transactions.

In at least some embodiments, the mobile device 104 may be configured to communicate with the security token device 102 through the receiver 120 and the transmitter 122. The receiver 120 and the transmitter 122 may be combined into a single functional unit, such as a transceiver, or may be separated into different functional units. Any of the transmitters 112, 122 and receivers 114, 120 shown in FIG. 1 or other figures can be configured to operate in a wired or wireless configuration. In wireless configurations, the transmitters 112, 122 and the receivers 114, 120 can be implemented, respectively, as wireless transmitters and wireless receivers that use one or more wireless communications methods, including: IEEE 802.11, IEEE 802.16, Bluetooth®, Bluetooth Low Energy®, Bluetooth SMART®, Wi-Fi, Near Field communications, ZigBee, or any other suitable wireless communication method. In at least some implementations described herein, the mobile device 104 can wirelessly detect the presence of the security token device 102 when the mobile device 104 comes in close proximity to the security token device 102.

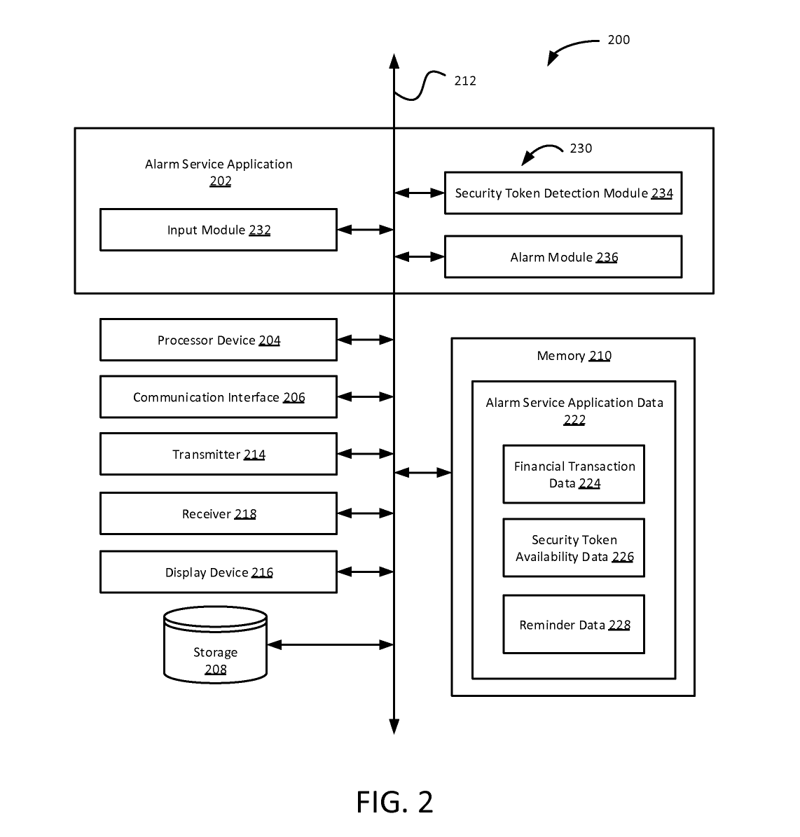

The alarm service application 128 may generally be configured to receive financial transaction data, which can include a subset of the alarm service application data 124 shown in FIG. 1. The alarm service application 128 may also be configured to detect whether the security token 110 is presently available and to generate a corresponding one of the reminders 126 to complete the financial transaction when the security token 110 becomes available. In some implementations, the alarm service application 128 may be implemented using hardware including a field-programmable gate array (FPGA) or an application-specific integrated circuit (ASIC). In other implementations, the alarm service application 128 may be implemented using a combination of hardware and software. An example implementation of an alarm service application that may correspond to the alarm service application 128 of FIG. 1 is described in greater detail below with respect to FIG. 2.

FIG. 2 is a block diagram illustrating an example alarm service support system 200 (hereinafter “system”) to facilitate financial transactions, arranged in accordance with at least some embodiments described herein. The system 200 may include or correspond to the mobile device 104 of FIG. 1. The system 200 may be implemented as a computing device having any suitable form factor, such as a cellular phone, a smartphone, a desktop computer, a laptop, a tablet device, a personal digital assistant (PDA), a personal digital assistant (PDA), a smart watch, a wearable device, or other suitable computing device.

The system 200 may include an alarm service application 202, a processor device 204, a communication interface 206, storage 208, memory 210, a transmitter 214, and a receiver 218, according to some examples. The components of the system 200 may be communicatively coupled by a bus 212. The bus 212 may include one or more of: a memory bus, a storage interface bus, a bus/interface controller, an interface bus, or other suitable bus. In some implementations, the system 200 additionally includes a display device 216 that may be configured to display instructions and/or other financial transaction information to the user 106.

The processor device 204 can include an arithmetic logic unit, a microprocessor, a general-purpose controller, or some other processor or processor array to perform or control performance of operations as described herein. The processor device 204 processes data signals and may include various computing architectures including a complex instruction set computer (CISC) architecture, a reduced instruction set computer (RISC) architecture, or an architecture implementing a combination of instruction sets. Although FIG. 2 includes a single processor device 204, multiple processor devices may be included. Other processors, operating systems, and physical configurations may be possible.

The communication interface 206 may be configured to receive and/or transmit data to and from the security token device 102 of FIG. 1. In some implementations, the communication interface 206 includes a port for direct physical connection to the security token device 102 or to another communication channel associated with other computing devices (not shown). For example, the communication interface 206 may include a universal serial bus (USB) port, a secure digital (SD) port, a category 5 cable (CAT-5) port, or similar port for wired communication with the security token device 102. In some implementations, the communication interface 206 includes the transmitter 214 and the receiver 218 for exchanging data with the security token device 102 of FIG. 1 or other communication channels. In these and other embodiments, the transmitter 214 and the receiver 218 may be implemented, respectively, as a wireless transmitter and a wireless receiver that use one or more wireless communication methods, including IEEE 802.11, IEEE 802.16, Bluetooth®, Bluetooth Low Energy®, Bluetooth SMART®, Wi-Fi, Near Field communications, ZigBee, or any other suitable wireless communication method to communicate with the security token device 102. The transmitter 214 may include or correspond to the transmitter 122 of FIG. 1 and/or the receiver 218 may include or correspond to the receiver 120 of FIG. 1.

In some implementations, the communication interface 206 includes a cellular communications transceiver for sending and receiving data over a cellular communications network including via short messaging service (SMS), unstructured supplementary service data (USSD), multimedia messaging service (MMS), hypertext transfer protocol (HTTP), direct data connection, wireless application protocol (WAP), e-mail, or another suitable type of electronic communication. In some implementations, the communication interface 206 includes a wired port and a wireless transceiver. The communication interface 206 may also provide other connections to a network (not shown) for data communication using standard network protocols including transmission control protocol/internet protocol (TCP/IP), HTTP, HTTP secure (HTTPS), and simple mail transfer protocol (SMTP), etc.

The storage 208 may include a non-transitory storage medium that stores instructions and/or data for providing the functionality described herein. The storage 208 may include a dynamic random access memory (DRAM) device, a static random access memory (SRAM) device, flash memory, or some other memory devices. In some implementations, the storage 208 also includes a non-volatile memory or similar permanent storage and media including a hard disk drive, a floppy disk drive, a CD-ROM device, a DVD-ROM device, a DVD-RAM device, a DVD-RW device, a flash memory device, or some other mass storage for storing information on a more permanent basis. The storage 208 may also store instructions and/or data that are temporarily stored or loaded into the memory 210.

The memory 210 stores instructions or data that may be executed or operated on by the processor device 204. The instructions or data may include programming code that may be executed by the processor device 204 to perform or control performance of the operations described herein. The memory 210 may include a dynamic random access memory (DRAM) device, a static random access memory (SRAM) device, flash memory, or some other memory device. In some implementations, the memory 210 also includes a non-volatile memory or similar permanent storage and media including a hard disk drive, a floppy disk drive, a CD-ROM device, a DVD-ROM device, a DVD-RAM device, a DVD-RW device, a flash memory device, or some other mass storage for storing information on a more permanent basis.

The memory 210 may store alarm service application data 222. The alarm service application data 222 may include financial transaction data 224, security token availability data 226, and reminder data 228. The alarm service application data 222 may correspond to the alarm service application data 124 of FIG. 1.

The financial transaction data 224 may include information associated with one or more financial transactions. For example, the financial transaction data 224 may include one or more of a bank account number, a credit card number, a debit card number, a user name, a password, login or identification information, an amount of the financial transaction, or any other suitable information associated with a financial transaction. Moreover, the financial transaction data 224 may include multiple subsets of financial transaction data. For example, the financial transaction data 224 may include a subset of financial transaction data that pertains to the sender/remitter (e.g., sender's bank account number) and another subset of financial transaction data that pertains to the receiver/remittee (e.g., receiver's bank account number).

The security token availability data 226 may include information associated with a present availability or presence of a security token which is needed to complete a financial transaction. For example, the security token availability data 226 may include an indication that a necessary security token is, or is not, presently available. The security token availability data 226 may also include information that uniquely identifies which security token is needed to complete the financial transaction. For example, if a user 106 has two different bank accounts, each associated with its own security token, the security token availability data 226 may include identifiers that associate each security token with its respective bank account. In this manner, the alarm service support system 200 can determine which security token is needed based on the bank account chosen for a particular financial transaction.

The reminder data 228 may include information associated with a reminder, such as a corresponding one of the reminders 126 of FIG. 1. For example, the reminder data 228 may include an indication that a reminder should or should not be generated for a particular financial transaction based on the present availability of a security token that is needed for the financial transaction. The reminder data 228 may also include scheduling information that relates to the timing of when the reminder 126 should be generated. The reminder data 228 may also include information associated with a form or presentation of the reminder 126. For example, a user 106 may wish to receive a graphical reminder via the display device 216, an audible reminder via a speaker (not shown), a vibration reminder via a vibration motor (not shown), and/or a reminder with any other suitable form or presentation.

As illustrated in FIG. 2, the alarm service application 202 may include at least one of: an input module 232, a security token detection module 234, or an alarm module 236, collectively referred to herein as “modules” 230. The alarm service application 202, including the modules 230, may generally include software that includes programming code and/or computer-readable instructions executable by the processor device 204 to perform or control performance of the functions and operations described herein. The alarm service application 202, including one or more of the modules 230, may receive data from another one of the components of the system 200 and may store the data in one or both of the storage 208 and the memory 210.

The input module 232 may generally be configured to receive financial transaction data that may be included in the financial transaction data 224. The security token detection module 234 may generally be configured to determine whether a security token is or is not available to authenticate the financial transaction. The alarm module 236 may generally be configured to schedule the reminders 126 of FIG. 1, generate the reminders 126, and determine the form/presentation of each of the reminders 126.

An example implementation that involves the system 200 of FIG. 2, implemented as the mobile device 104 in the operating environment 100 of FIG. 1, will now be discussed with combined reference to FIGS. 1 and 2. The user 106 may initiate a financial transaction with his or her mobile device 104 by entering financial transaction data 224 associated with the financial transaction into the alarm service application 202 on the mobile device 104 via the input module 232. The financial transaction data 224 may be utilized by the alarm service application 202, or by any other component of the system 200. Some implementations of the input module 232 may include an interactive graphical user interface (GUI) that is output to a display device 216 and is configured to receive financial transaction data 224 from the user 106. The input module 232 may alternately or additionally include or be communicatively coupled to one or more input devices, such as a touchscreen, a typewriter, a mouse, a microphone, or other any other suitable input device configured to receive financial transaction data 224.

After sufficient financial transaction data 224 is received to adequately define the financial transaction, the security token detection module 234 can be configured to determine whether the security token 110 is available to effect the financial transaction. In at least some implementations, the security token detection module 234 can directly request the security token 110 from the user 106 via the display device 216 with the interactive GUI (not shown). The interactive GUI may include a place to enter the security token 110 (e.g., a one-time password), a button to effect the financial transaction after the security token 110 has been entered (e.g., an “OK” button), and a button to indicate that the security token 110 is not presently available (e.g., a “Transfer Later” button). In this example, the security token detection module 234 can be configured to determine whether a security token 110 is available based on user 106 input. In other implementations, the security token detection module 234 can be configured to determine whether a security token 110 is available by searching for beacon signals emitted by the security token device 102 with receivers 120, 218 and/or other sensors (not shown). In at least some implementations, the beacon signals are wireless signals. In a particular implementation, the security token detection module 234 is configured to determine whether a security token 110 is presently available by searching for Bluetooth® low energy signals emitted by the security token device 102. In other implementations, the security token detection module 234 can include sensors (not shown) configured to search for beacon signals emitted by the security token device 102, such as audible signals, light signals, magnetic signals, or any other beacon signal that may be used to detect the presence of the security token device 102. These sensors may include microphones, light sensors, hall-effect sensors, etc.

If the user 106 selects the button that indicates the security token 110 is not presently available, and/or the security token detection module 234 cannot detect beacon signals emitted from the security token device 102, then the security token detection module 234 may determine that a security token 110 is not presently available to effect the financial transaction. In this case, the security token detection module 234 can be configured to update the security token availability data 226 to indicate that a security token 110 is not presently available and that a financial transaction is pending. The security token detection module 234 can also be configured to enter a search mode in which the security token detection module 234 searches for beacon signals emitted from the security token device 102, such as Bluetooth® pairing signals or other suitable signals, or otherwise searches for an indication that the system 200 is in the proximity of the security token device 102. In these and other implementations, Bluetooth and/or another wireless signal may be received by the receiver 120 or 218 when in proximity to the security token device 102, where the wireless signal may indicate that the security token 110 is available. The security token detection module 234 may search continuously, continually, periodically, randomly, pseudo-randomly, or according to any suitable timing, After the pending financial transaction is completed, and/or the reminder 126 is dismissed, the security token detection module 234 can be configured to exit the search mode to conserve power.

The alarm module 236 may be configured to detect pending financial transactions associated with security token availability data 226 that indicates that the security token 110 is not available. In this case, the alarm module 236 may schedule a corresponding one of the reminders 126 to complete the financial transaction later when the security token 110 is available. The reminder 126 may include associated reminder data 228, such as the particular form/presentation of the reminder 126 and/or timing information defining when the reminder 126 should be generated. In some implementations, the alarm module 236 can immediately schedule and generate the reminder 126 as a graphical reminder to complete the transaction when the security token 110 becomes available. In yet other implementations, the alarm module 236 can schedule the reminder 126 to be generated when the security token detection module 234 determines that the security token 110 becomes available in the future. For example, the mobile device 104 may include location identification capabilities, such as Global Positioning System (GPS). The location of the security token device 102 (e.g., the user's home), may be known and/or programmed into the mobile device 104 such that when the mobile device 104 detects its location is near the location of the security token device 102, a reminder 126 is generated to complete the financial transaction.

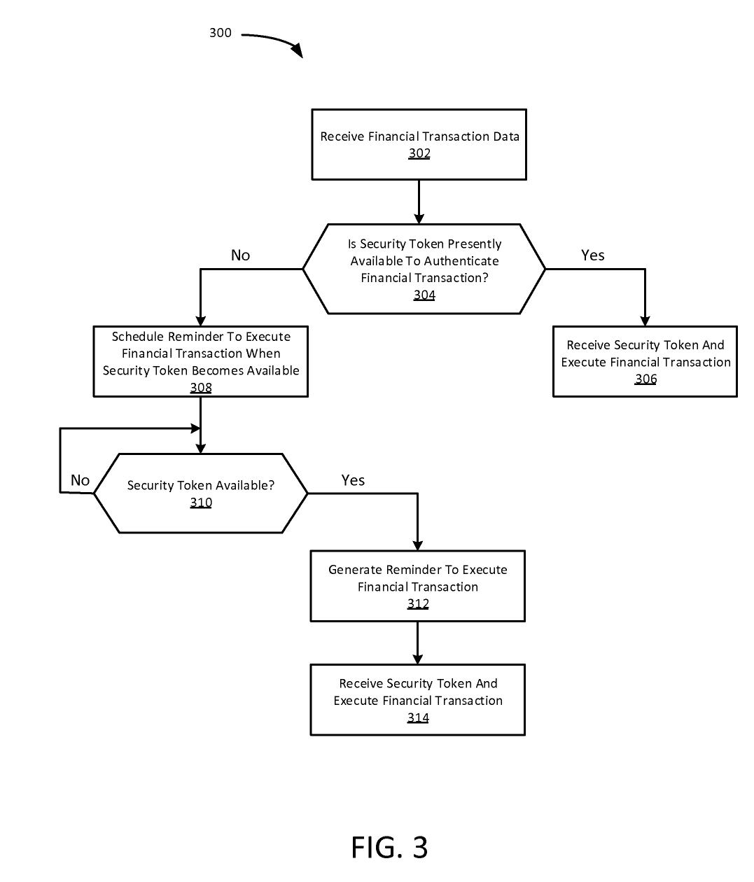

FIG. 3 shows an example flow diagram of a method 300 to facilitate financial transactions with an alarm service, arranged in accordance with at least some embodiments described herein. The method 300 may be implemented, in whole or in part, by the mobile device 104 of FIG. 1, the system 200 of FIG. 2, or another suitable device or system. For convenience in the discussion that follows, the method 300 may be discussed in the context of the operating environment 100 of FIG. 1 and/or the system 200 of FIG. 2. The method 300 may be implemented in or by other operating environments and/or systems than are illustrated in FIGS. 1 and 2. The method 300 may begin at block 302.

In block 302 (“Receive Financial Transaction Data”), financial transaction data may be received from the user 106 through input module 232 and/or may be stored in memory 210, as previously discussed. Block 302 may be followed by block 304.

In block 304 (“Is Security Token Presently Available To Authenticate Financial Transaction?”), it may be determined whether a security token is presently available to authenticate the financial transaction. For instance, it may be determined whether the security token 110 is presently available to authenticate the financial transaction. Block 304 may be followed by block 306 (“Yes” at block 304) or by block 308 (“No” at block 304) depending on whether the security token is presently available to authenticate the financial transaction.

In block 306 (“Receive Security Token And Execute Financial Transaction”), if it is determined at block 304 that the security token 110 is presently available to authenticate the financial transaction, the security token 110 can be received and the financial transaction can be executed.

In block 308 (“Schedule Reminder To Execute Financial Transaction When Security Token Becomes Available”), if it is determined at block 304 that the security token 110 is not presently available to authenticate the financial transaction, the reminder 126 can be scheduled to execute the financial transaction when the security token 110 becomes available. Block 308 may be followed by block 310.

In block 310 (“Security Token Available?”), the method 300 can enter a search mode where the method 300 searches for the security token 110 to become available. Block 310 may be recursively followed by block 310 (“No” at block 310) or by block 312 (“Yes” at block 310) depending on whether the security token 110 has become available.

In block 312 (“Generate Reminder To Execute Financial Transaction”), if it is determined at block 310 that the security token 110 has become available, a reminder can be generated to remind the user 106 to execute the financial transaction. Block 312 can be followed by block 314.

In block 314 (“Receive Security Token And Execute Financial Transaction”), the security token 110 can be received and the financial transaction can be executed.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed implementations.

The implementations described herein may include the use of a special purpose or general-purpose computer including various computer hardware or software modules, as discussed in greater detail below.

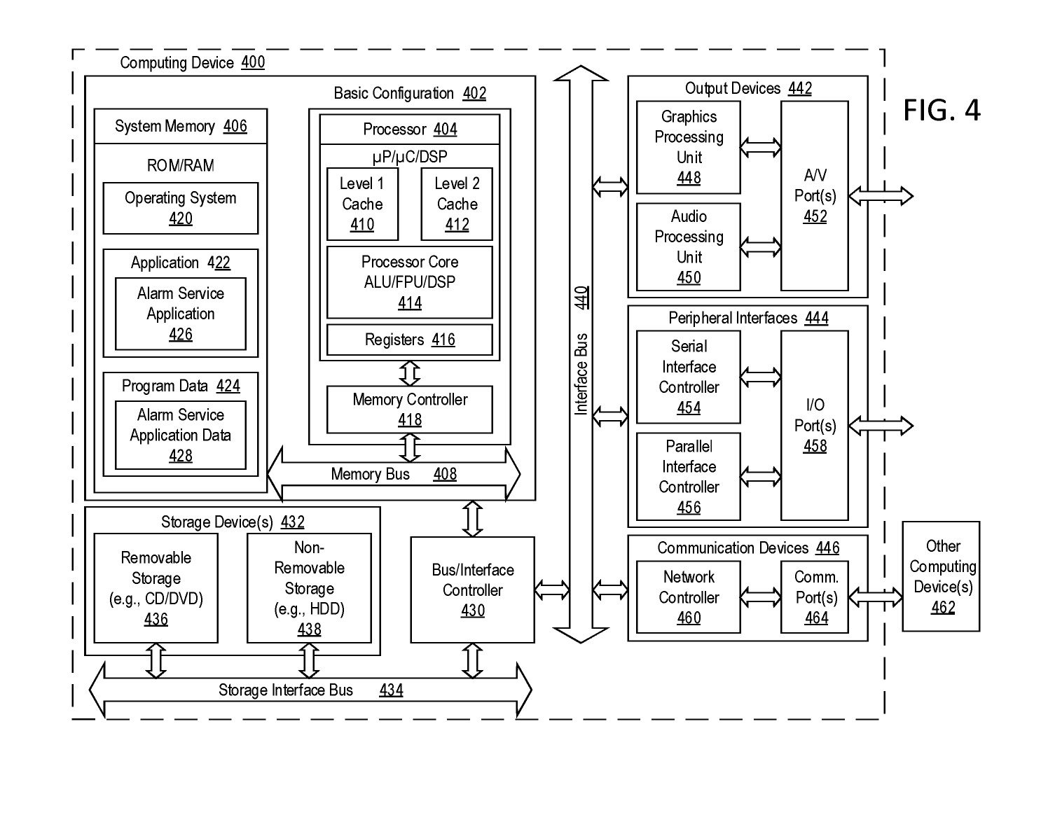

FIG. 4 is a block diagram illustrating an example computing device 400 configured to facilitate financial transactions with an alarm service, arranged in accordance with at least some embodiments described herein. In a very basic configuration 402, computing device 400 typically includes one or more processors 404 and a system memory 406. A memory bus 408 may be used for communicating between processor 404 and system memory 406.

Depending on the desired configuration, processor 404 may be of any type including a microprocessor (μP), a microcontroller (μC), a digital signal processor (DSP), or any combination thereof. Processor 404 may include one or more levels of caching, such as a level one cache 410 and a level two cache 412, a processor core 414, and registers 416. The example processor core 414 may include an arithmetic logic unit (ALU), a floating point unit (FPU), a digital signal processing core (DSP Core), or any combination thereof. An example memory controller 418 may also be used with processor 404, or in some implementations memory controller 418 may be an internal part of processor 404.

Depending on the desired configuration, system memory 406 may be of any type including volatile memory (such as RAM), nonvolatile memory (such as ROM, flash memory, etc.), or any combination thereof. System memory 406 may include an operating system 420, one or more applications 422, and program data 424. Application 422 may include an alarm service application 426 that may correspond to the alarm service application 128, 202 of FIGS. 1 and 2. Program data 424 may include alarm service application data 428 that may correspond to the alarm service application data 124, 222 of FIGS. 1 and 2. In some embodiments, application 422 may be arranged to operate with program data 424 on operating system 420 to perform a method to facilitate financial transactions with an alarm service, such as the method 300 of FIG. 3, and/or to perform other methods and/or operations described herein.

Computing device 400 may have additional features or functionality, and additional interfaces to facilitate communications between basic configuration 402 and any required devices and interfaces. For example, a bus/interface controller 430 may be used to facilitate communications between basic configuration 402 and one or more data storage devices 432 via a storage interface bus 434. Data storage devices 432 may be removable storage devices 436, non-removable storage devices 438, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer-readable instructions, data structures, program modules, or other data.

System memory 406, removable storage devices 436, and non-removable storage devices 438 are examples of computer storage media. Computer storage media includes RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store the desired information and which may be accessed by computing device 400. Any such computer storage media may be part of computing device 400.

Computing device 400 may also include an interface bus 440 for facilitating communication from various interface devices (e.g., output devices 442, peripheral interfaces 444, and communication devices 446) to basic configuration 402 via bus/interface controller 430. Example output devices 442 include a graphics processing unit 448 and an audio processing unit 450, which may be configured to communicate to various external devices such as a display or speakers via one or more A/V ports 452. Example peripheral interfaces 444 include a serial interface controller 454 or a parallel interface controller 456, which may be configured to communicate with external devices such as input devices (e.g., keyboard, mouse, pen, voice input device, touch input device, etc.), sensors (e.g., receivers 120, 218, microphone sensors, light sensors, magnetic sensors, etc.), or other peripheral devices (e.g., printer, scanner, etc.) via one or more I/O ports 458. An example communication device 446 includes a network controller 460, which may be arranged to facilitate communications with one or more other computing devices 462 over a network communication link via one or more communication ports 464.

The network communication link may be one example of a communication media. Communication media may typically be embodied by computer-readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term “computer-readable media” as used herein may include both storage media and communication media.

Computing device 400 may be implemented as a portion of a small-form factor portable (or mobile) electronic device such as a cell phone, a smartphone, a personal data assistant (PDA), a personal media player device, a wireless web-watch device, a personal headset device, an application-specific device, a smart watch, a wearable device, or a hybrid device that includes any of the above functions. Computing device 400 may also be implemented as a personal computer including both laptop computer and non-laptop computer configurations. The computing device 400 of FIG. 4 can be an example implementation of the mobile device 104, and/or the system 200 of FIGS. 1 and 2.

The present disclosure is not to be limited in terms of the particular embodiments described herein, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. It is to be understood that the present disclosure is not limited to particular methods, reagents, compounds compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible sub ranges and combinations of sub ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into sub ranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, various embodiments of the present disclosure have been described herein for purposes of illustration, and various modifications may be made without departing from the scope and spirit of the present disclosure. Accordingly, the various embodiments disclosed herein are not intended to be limiting, with the true scope and spirit being indicated by the following claims.

What is claimed is:

1. A method to facilitate financial transactions, the method comprising:
receiving data relating to a financial transaction;
determining that a security token is not presently available to authenticate the financial transaction; and
in response to determining that the security token is not presently available, scheduling a reminder to execute the financial transaction when the security token becomes available.

2. The method of claim 1 further comprising determining that the security token is available and in response to determining that the security token is available, generating the reminder to execute the financial transaction.

3. The method of claim 2, further comprising determining that the security token is available in response to receiving a wireless signal from a device associated with the security token.

4. The method of claim 3, wherein receiving the wireless signal from the device associated with the security token comprises receiving a Bluetooth low energy signal from the device associated with the security token.

5. The method of claim 1, wherein determining that the security token is not presently available comprises determining that a one-time password is not presently available.

6. The method of claim 1, wherein determining that the security token is not presently available comprises determining that a software token is not presently available.

7. The method of claim 1, wherein receiving the data relating to the financial transaction comprises receiving at least one of a bank account number, a credit card number, a debit card number, a password, or an amount of the financial transaction.

8. A system to facilitate financial transactions, the system comprising:
an input module configured to receive data related to a financial transaction;
a security token detection module configured to detect that a security token is not presently available to authenticate the financial transaction; and
an alarm module configured to schedule a reminder to execute the financial transaction when the security token becomes available.

9. The system of claim 8, wherein the security token detection module is further configured to detect that the security token is available and the alarm module is further configured to generate the reminder to execute the financial transaction in response to the security token detection module detecting that the security token is available.

10. The system of claim 9, further comprising a wireless receiver configured to receive a wireless signal indicating that the security token is available.

11. The system of claim 10, wherein the wireless signal comprises a Bluetooth low energy signal.

12. The system of claim 8, wherein the security token comprises a one-time password.

13. The system of claim 8, wherein the security token comprises a software token.

14. The system of claim 8, wherein the data relating to the financial transaction comprises at least one of a bank account number, a credit card number, a debit card number, a password, and an amount of the financial transaction.

15. A non-transitory computer-readable medium that includes computer-readable instructions stored thereon that are executable by a processor to perform or control performance of operations comprising:
receiving data relating to a financial transaction;
determining that a security token is not presently available to authenticate the financial transaction; and
in response to determining that the security token is not presently available, scheduling a reminder to execute the financial transaction when the security token becomes available.

16. The non-transitory computer-readable medium of claim 15, wherein the operations further comprise determining that the security token is available and in response to determining that the security token is available, generating the reminder to execute the financial transaction.

17. The non-transitory computer-readable medium of claim 16, wherein the operations further comprise receiving a wireless signal from a device associated with the security token indicating that the security token is available.

18. The non-transitory computer-readable medium of claim 17, wherein receiving the wireless signal from the device associated with the security token comprises receiving a Bluetooth low energy signal from the device associated with the security token.

19. The non-transitory computer-readable medium of claim 15, wherein determining that the security token is not presently available comprises determining that a one-time password is not presently available.

20. The non-transitory computer-readable medium of claim 15, wherein determining that the security token is not presently available comprises determining that a software token is not presently available.
